(19) United States
(12) Patent Application Publication
(10) Pub. No.: US 2014/0304300 A1
(43) Pub. Date: Oct. 9, 2014

(54) System and Method for Offering and Pairing Remote Laboratory Course Sections with Online Course Sections

(71) Applicants: Jeffrey Morris Cogen, Flemington, NJ (US); Vivek Tomer, Philadelphia, PA (US)

(72) Inventors: Jeffrey Morris Cogen, Flemington, NJ (US); Vivek Tomer, Philadelphia, PA (US)

(21) Appl. No.: 14/246,850

(22) Filed: Apr. 7, 2014

Related U.S. Application Data
(60) Provisional application No. 61/853,449, filed on Apr. 6, 2013.

(51) Int. Cl. G06F 17/30

(52) U.S. Cl. CPC G06F 17/30867; G06F 17/30545
USPC 707/770

(57) ABSTRACT

This invention is a system and method for retrieving and displaying information relating to college courses with separate lecture and laboratory portions. This invention is also a system and method for storing and retrieving records of completion of those courses. The laboratory portion can be held anywhere, allowing online courses to offer lab work as part of their curriculum.

### CROSS-REFERENCE TO RELATED APPLICATIONS

This U.S. non-provisional application claims the benefit of the priority date of U.S. provisional application 61/853,449, filed Apr. 6, 2013.

### FIELD OF THE INVENTION

This invention relates generally to providing university education, specifically to systems and methods for offering remote laboratory courses.

### BACKGROUND OF THE INVENTION

Colleges and universities are increasingly offering at least some of their courses online, i.e. they are online colleges and universities. Online courses are characterized by replacement of attendance for in-person lectures by some combination of one or more of Internet, video, computer, tablet or phone learning. While online courses work well for many subjects, some subjects traditionally involve hands-on laboratory instruction. This is especially the case for some fields with the most promising employment prospects, such as in the sciences and engineering. Chemistry, Biology, Engineering, Physics, Botany, and Biochemistry are just some examples of subjects that typically require extensive hands-on laboratory education. Some other examples include medical and related sciences, electronics technology, information technology, automobile technical training and computer networking. This poses a challenge for online colleges and universities and students. Students increasingly wish to take online courses, and colleges and universities wish to meet student needs by offering online courses and degrees. Yet, some of the most promising fields do not readily lend themselves to an exclusively online learning curriculum on account of a need for hands-on laboratory training.

Traditionally, online colleges and universities have in some cases required students of online courses to spend time in residence at the campuses of the online colleges and universities to complete hands-on laboratory course work. This presents a difficulty for the students, because many students that take online courses live far away from the campuses of the online colleges or universities where they wish to take online courses, in some cases even in other countries or on other continents. In some cases, online colleges or universities may accept credits for courses that the student has completed at a second college or university, such courses including at least a non-laboratory component and optionally including a laboratory component, both of which are completed at the second college or university. Such is the case when a student transfers full course credits from another, second college or university. For several reasons, having students complete full courses at a second college or university is not ideal, including loss of business for the online college or university, inability of the online college or university to standardize the education received by the student, necessity for the student desiring online learning at the online college or university to complete the non-laboratory coursework in a remote non-online environment at the second college or university, and a general difficulty in coordinating such coursework toward completion of a degree (bachelor's, associates, Ph.D., or other degree or certification). In other cases, online colleges and universities may altogether forego hands-on laboratory training and instead require their students to do virtual laboratories in which they watch videos or view online pictures of key laboratory procedures. But these virtual laboratories do not provide the hands-on training needed to master many experimental techniques, and it is likely that a significant number of selective employers will place a relatively low value on science and engineering degrees and other degrees and certifications that are earned without completing extensive hands-on laboratory training

### BRIEF SUMMARY OF THE INVENTION

The present invention is a system and method for offering a laboratory portion of a course at a location remote to the online college or university so that the online student can obtain hands-on laboratory experience without traveling long distance while participating in an online course or online curriculum at the online college or university.

The present invention, in one embodiment, is a system and method for storing an electronic record of completion of an online course, and storing an electronic record of completion of a remote laboratory portion of a course, and optionally displaying student records comprising information about one or more completed online courses and information about one or more completed remote laboratory portion of a course.

In another embodiment, the invention is a computer system configured to display one or more offerings of local laboratory portion of a course accepted for credit at an online college or university, wherein the local laboratory portion of a course is administered by a party other than the online college or university.

In another embodiment, the invention is a computer system configured to offer information about availability of a local laboratory portion of a course combined with offering information about online course options, to comprise a portion of a listing of options or requirements for completion of a degree or certification at an online college or university.

In another embodiment, the invention is a computer system configured to store records of completion of a local laboratory portion of a course and to retrieve the records for combining with records of completed online courses and online portions of courses in order to display or store a composite record of completed courses toward a degree or certification.

### BRIEF DESCRIPTION OF THE DRAWINGS

The foregoing features of the present disclosure will be more readily understood by reference to the following detailed description, taken with reference to the accompanying drawings, in which:

FIG. 1 is a flowchart illustrating an embodiment of the invention.

FIG. 2 is a flowchart illustrating another embodiment of the invention.

FIG. 3 is a flowchart illustrating the interaction of courses displayed to students and the database in an embodiment of the invention.

FIG. 4 is a flowchart illustrating the interaction of courses displayed to students, the database, and the course management system in another embodiment of the invention.

FIG. 5 shows a student record displayed on a viewscreen in an embodiment of the invention.

FIG. 6 shows a listing of courses requiring laboratory credits displayed on a viewscreen in an embodiment of the invention.

FIG. 7 shows a listing of courses fulfilling laboratory credits displayed on a viewscreen in an embodiment of the invention.

FIG. 8 shows a listing of courses fulfilling laboratory credits displayed on a viewscreen in another embodiment of the invention.

### DETAILED DESCRIPTION OF THE INVENTION

### Definitions

Online course. We adopt the definition of online course put forth by I. E. Allen and Jeff Seaman in “Staying the Course: Online Education in the United States, 2008” published by the Sloan Consortium, in which an online course is defined as a course in which 80% or more of the course content is delivered online. In the preferred embodiment of the invention, 100% of the course content is delivered online.

Online college or university. An “online college” or “online university” or “online college or university” refers to any college, university or other educational institution or organization, including community colleges, offering one or more online courses.

Database. The term database is well known in the art. Well-known database management systems (“DBMSs”) include MySQL, PostgreSQL, SQLite, Microsoft SQL Server, Microsoft Access, Oracle, Sybase, dBASE, FoxPro, and IBM DB2. Different DBMSs can inter-operate by using standards such as SQL and ODBC or JDBC to allow a single application to work with more than one database.

Educational Institution or EI. For purposes of this disclosure, educational institution refers to a college or university offering an online course, degree or certification.

Online course system 30. An online course system is that which is used to conduct an online course. These are well known in the art, and typically comprise information technology components at the educational institution, including databases, computer networks, network data storage devices, servers, routers, switches, Internet connections, tablets, smart phones, and computers. In some cases, printed materials may also be part of the online course system if they are utilized as required reading for online courses.

Online degree. This refers to a degree or certification offered by an educational institution, wherein at least 50% of the required course credits are online courses. Non-limiting examples of certifications and degrees are Bachelor of Science (BS) degree, Bachelor of Arts (BA) degree, Masters degree (MA or MS), Doctor of Philosophy (Ph.D.) degree, Associates degree, MD, Certified Automotive Engineer, Medical Ultrasound Technician, etc.

Laboratory. Laboratory refers to a location or structure equipped for experimental study in a science or for testing and analysis; broadly: a place providing opportunity for experimentation, observation, or practice in a field of study. In some embodiments, a laboratory is defined as a room or building equipped for scientific experimentation or research, or an academic period devoted to independent or collaborative work or study in such a place.

Laboratory course. A laboratory course, or laboratory portion of a course, is defined as a course that is completed with the student being in attendance in the laboratory in order to receive hands-on training, and containing little or no traditional in-person lecture component. Though there may be relatively small amounts of in-person lecture associated with the laboratory course, a laboratory course or laboratory portion of a course will typically have less or much less than 30% of the in-person course time at the laboratory location consumed by lecture, and in some embodiments, less than 20% of the in-person course time at the laboratory location consumed by lecture, and in some embodiments, less than 10% of the in-person course time at the laboratory location consumed by lecture. Lecture refers to in-person classroom instruction in which an instructor speaks in front of a class for the purpose of teaching. In-person course time refers to time when the student is in the same location as the instructor, which can be contrasted with online instruction in which the student and the instructor are not in the same location.

Remote laboratory. Remote laboratory 10 refers to a laboratory that is not located within a building or within a campus of the online university, and typically is located greater than 20 miles away, and in some embodiments, greater than 50 miles away, and in some embodiments, greater than 100 miles away from a classroom, campus, or laboratory owned or operated by the educational institution.

Remote laboratory course. Remote laboratory course, or remote laboratory portion of a course, refers to a laboratory course that is conducted at a remote laboratory.

Online portion of a course. In cases where an online curriculum or partially online curriculum includes at least one remote laboratory course, online course may also be referred to as “online portion of a course” or as “online lecture”.

Record of completion of online course 40. This refers to a document, certificate, electronic file, voice message (recorded or live), email, or other type of written, audio, video, electronic, or digital message that serves to store, or relay for storage elsewhere, information used to verify that a student has completed an online course. Generally, a “record of completion of online course” will include one or more pieces of identifying information, non-limiting examples of which are student name, student ID, or social security number, as well as including one or more pieces of information about the course or courses that have been completed, non-limiting examples of which include course name, course description, number of credits received, location of the course, and grade received in the course (or pass/fail data).

Record of completion of a remote laboratory course 20. This refers to a document, certificate, electronic file, voice message (recorded or live), email, or other type of written, audio, video, electronic or digital message that serves to store, or relay for storage elsewhere, information used to verify that a student has completed a remote laboratory course. Generally, the “record of completion of a remote laboratory course” will include one or more pieces of identifying information, non-limiting examples of which are student name, student ID, or social security number, as well as including one or more pieces of information about the course that has been completed, non-limiting examples of which include course name, course description, number of credits received, location of the course, and grade received in the course (or pass/fail data).

Computer. A computer, computer system, or computing device (herein used interchangeably where appropriate), refers to any of a variety of suitable computing devices including, for example, a desktop computer, laptop, netbook or notebook computer, network terminal, tablet, smart phone, mobile phone, gaming device or other device able to communicate with one or more computing systems, servers or databases via a network interface and a network to, for example, transfer or access electronic records, files or data or communicate other information. For example, such computing systems, servers or databases can be a part of an educational institution database. Computers may be linked together via networks, including the Internet. Some or all of the computers described herein, including computers 80, 85 or 130, can be communicably coupled or linked together over one or more networks including, for example, the Internet or one or more private or proprietary networks.

Electronic record of completion of online course 70. This refers to an electronic file or database record comprising information used to verify that a student has completed an online course. It will include one or more pieces of identifying information, non-limiting examples of which are student name, student ID, or social security number as well as one or more pieces of information about the course that has been completed, non-limiting examples of which include course name, course description, number of credits received, location of the course, and grade received in the course (or pass/fail data). It will include one or more pieces of identifying information, non-limiting examples of which are student name, student ID, or social security number and will also include one or more pieces of information about the course that has been completed, non-limiting examples of which include course name, course description, number of credits received, location of the course, and grade received in the course (or pass/fail data).

Electronic record of completion of remote laboratory portion of course 60. This refers to an electronic file or database record comprising information used to verify that a student has completed a remote laboratory course. It will include one or more pieces of identifying information, non-limiting examples of which are student name, student ID, or social security number as well as one or more pieces of information about the course that has been completed, non-limiting examples of which include course name, course description, number of credits received, location of the course, and grade received in the course (or pass/fail data).

Educational institution database 50. This is a database or plurality of databases that maintain records of students and courses they have completed. The educational institution database will typically be owned and operated by the educational institution offering online courses, degrees or certifications. It will comprise data used to keep track of courses completed by the student. This will comprise data pertaining to online courses completed at the educational institution (electronic record of completion of online course), and may optionally comprise records pertaining to completion of one or more third party remote laboratory courses (electronic record of completion of remote laboratory portion of course).

Display of student records 90. This is a display comprising the record of completed courses for a student of the educational institution. In the preferred embodiment, it will include data pertaining to online courses completed at the educational institution as well as records pertaining to completion of one or more remote laboratory courses. Preferably the display will include both types of data together. However, in some embodiments the displays of each type are on separate pages, but are readily accessible via tabs or hyperlinks (internal or external to native website) or the like. The key feature is that the system enables the student to readily view all records of completed online classes and third party remote laboratory classes through or via a single web or computer software interface. In the preferred embodiment, the display will be on a computer, tablet, or smart phone screen, but optionally it may be printed or otherwise deposited on paper or other physical communication instrument.

Remote laboratory course management system 55. This is a computer system comprising one or more databases and interfaces to enable access via Internet, cellular, VPN, or other networks and corresponding connections and network interfaces. The remote laboratory course management system will typically be owned and operated by an entity other than the educational institution offering online courses. In a preferred mode, the entity that owns and operates the remote laboratory course management system is also different than the college or university that owns the laboratory where the remote laboratory course is taken. For example, in some embodiments the remote laboratory management system will be owned and operated by a company, corporation, partnership, organization or other enterprise that manages the process of pairing available remote laboratory course openings with students of online educational institutions that desire or are required to obtain hands-on laboratory training. The remote laboratory course management system will comprise data about available spots in remote laboratory courses. Optionally, the remote laboratory course management system will comprise student records pertaining to completion of one or more remote laboratory courses (electronic record of completion of remote laboratory portion of course).

Electronic record of online course offering 100. This refers to an electronic file or database record comprising information about available online courses. It will include one or more pieces of information about one or more online courses available at the educational institution, non-limiting examples of which include course name, course description, and number of credits offered for the course.

Electronic record of offering of remote laboratory portion of course 110. This refers to an electronic file or database record comprising information about available remote laboratory courses. It will include one or more pieces of information about one or more remote laboratory courses available at colleges or universities other than the educational institution, non-limiting examples of which include course name, course description, laboratory location, course dates and times, and number of credits offered for the course.

Internet 120. The Internet refers to the global system of interconnected computer networks that use the standard Internet protocol suite (TCP/IP). It is a network of networks that consists of millions of private, public, academic, business, and government networks, of local to global scope, that are linked by a broad array of electronic, wireless and optical networking technologies. The Internet carries an extensive range of information resources and services, such as the inter-linked hypertext documents of the World Wide Web (WWW) and the infrastructure to support email. It is understood that other types of networks or protocols may be utilized to enable access via interconnected computers and networks, and those other types are included in the scope of this disclosure to be interchangeable with the term Internet.

Display of offerings for online course and remote laboratory portion of course 140. This is a display comprising offerings of courses, including online courses and remote laboratory courses. In the preferred mode, it will include data pertaining to offerings of online courses at the educational institution as well as offerings of one or more remote laboratory courses. Preferably the display will include both types of data together. However, in one embodiment the displays of each type may be on separate pages, but are readily accessible via hyperlinks or the like. The key feature is that the system enables the student to readily view all pertinent records of available online and remote laboratory courses through or via a single web or computer software interface. In the preferred mode, the display will be on a computer, tablet, or smart phone screen, but optionally it may be printed or otherwise deposited on paper or other physical communication instrument.

### Additional Detailed Description

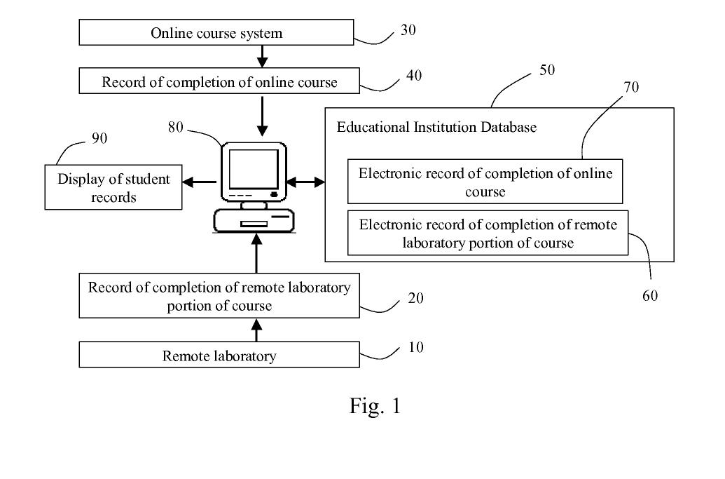

FIG. 1 illustrates one embodiment of the system. Students can take an online course via an online course system 30 operated by a first college or university (the educational institution). Students can take a remote laboratory course in a remote laboratory 10 in a hands-on, in-person laboratory setting at a second college or university that is, from the student's perspective, preferably located near where the student resides. Upon completion of the online course, a record of completion of online course 40 is generated by the educational institution offering the online course. And upon completion of a remote laboratory course, a record of completion of remote laboratory portion of course 20 is generated by the second college or university offering the remote laboratory course. Using a computer 80 an electronic record of completion of online course 70 and an electronic record of completion of remote laboratory portion of course 60 are created and stored in an educational institution database 50. Computer 80 also can be used to create a display of student records 90 from the educational institution database.

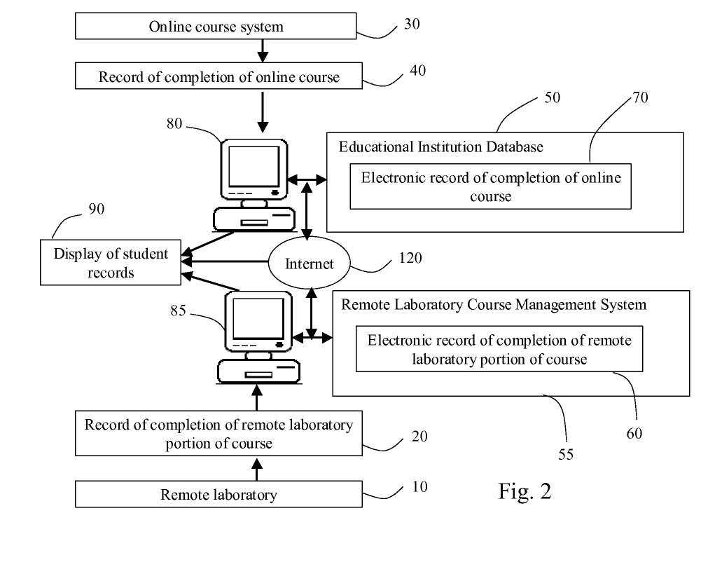

FIG. 2 illustrates another embodiment of the system. Students can take an online course via an online course system 30 run by a first college or university (the educational institution). Upon completion of an online course, a record of completion of online course 40 is generated by the educational institution that offered the online course. Students can take a remote laboratory course in a remote laboratory 10 in a hands-on, in person laboratory setting at a second college or university located near where the student resides. And upon completion of a remote laboratory course, a record of completion of remote laboratory portion of course 20 is generated by the second college or university offering the remote laboratory course. Using a computer 80 an electronic record of completion of online course 70 is created and stored at the first college or university and stored in an educational institution database 50. Using a second computer 85 an electronic record of completion of remote laboratory portion of course 60 is created and stored in a remote laboratory course management system 55. Computer 80 or computer 85 also can be used to create a display of student records 90, the display of student records comprising information from the educational institution database and from the remote laboratory course management system.

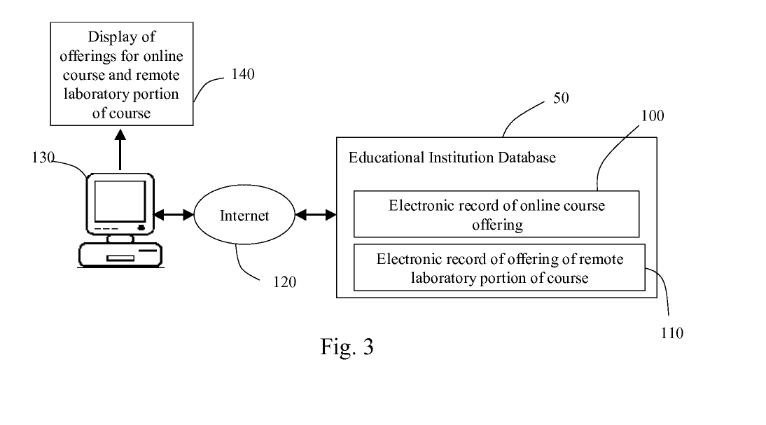

FIG. 3 illustrates another embodiment of the system. Educational institution database 50 comprises an electronic record of online course offering 100 and an electronic record of offering of remote laboratory portion of course 110. Using a computer 130 over the Internet 120 a student can view a display of offerings for online course and remote laboratory portion of course 140 to enable the student to make decisions about which courses to take.

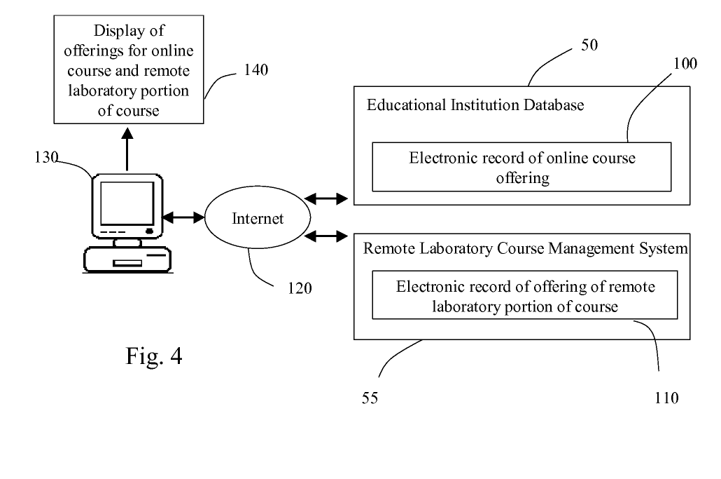

FIG. 4 illustrates another embodiment of the system. Educational institution database 50 comprises an electronic record of online course offering 100. Remote laboratory course management system 55 comprises an electronic record of offering of remote laboratory portion of course 110. Using a computer 130 over the Internet 120 a student can view a display of offerings for online course and remote laboratory portion of course 140 to enable the student to make decisions about which courses to take.

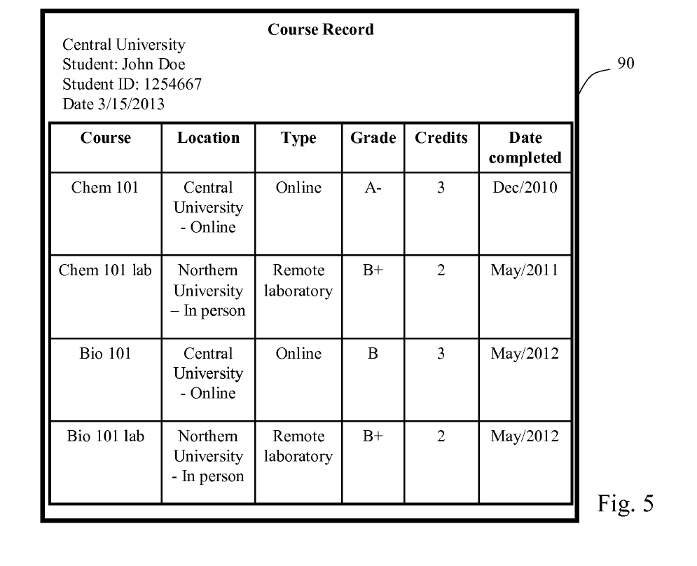

FIG. 5 shows display of student records 90, which comprises information derived from electronic record of completion of online course 70 (Chem 101 and Bio 101 in the case of FIG. 5) and also comprises information derived from electronic record of completion of remote laboratory portion of course 60 (Chem 101 lab and Bio 101 lab in the case of FIG. 5). In this hypothetical case illustrated in FIG. 5, Central University is located far from Northern University, and the student John Doe resides close to Northern University.

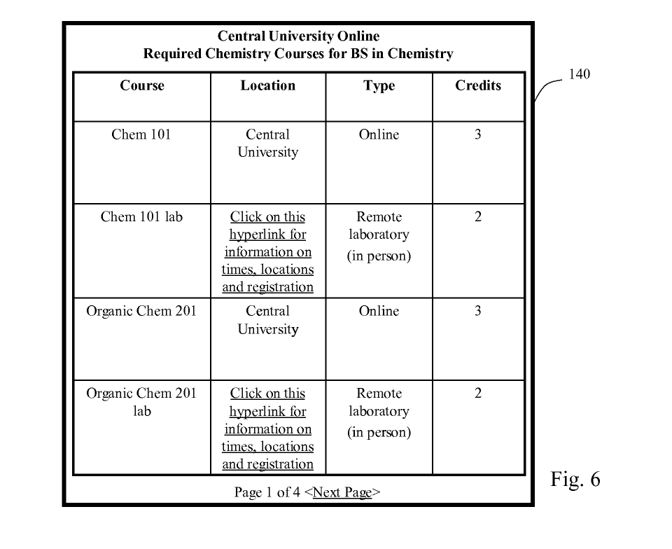

FIG. 6 displays offerings for online course and remote laboratory portion of course 140, which comprises information derived from an electronic record of online course offering 100 (Chem 101 and Organic Chem 201 in the case of FIG. 6) and also comprises information derived from an electronic record of offering of remote laboratory portion of course 110 (Chem 101 lab and Organic Chem 201 lab in the case of FIG. 6). In the case of the embodiment illustrated in FIG. 6, a hyperlink is available to take the student to additional details pertaining to the remote laboratory portion of course.

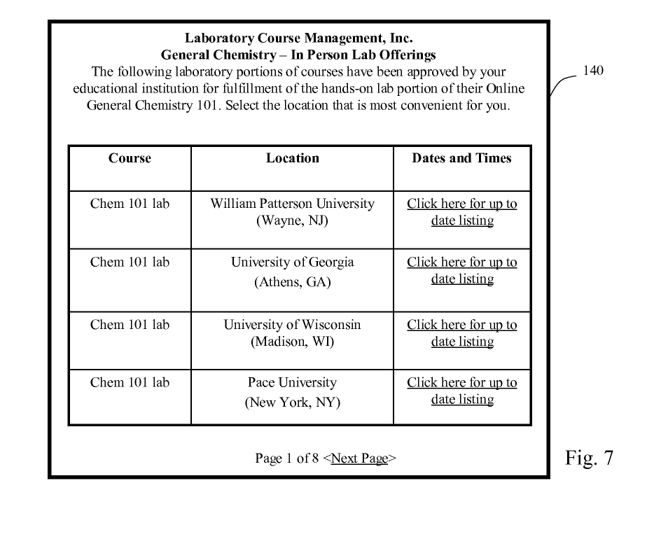

FIG. 7 displays offerings for online course and remote laboratory portion of course 140, which comprises information derived from an electronic record of online course offering 100 and also comprises information derived from an electronic record of offering of remote laboratory portion of course 110. In this particular embodiment the information displayed comprises a list of remote laboratory courses that can be used to fulfill requirements in accompaniment with online course offering General Chemistry 101. In this embodiment, the student is offered information about dates and times via hyperlinks. In a related embodiment, the student will have the option of searching for available remote laboratory course by location, by subject, by date, by time, and by various other useful parameters.

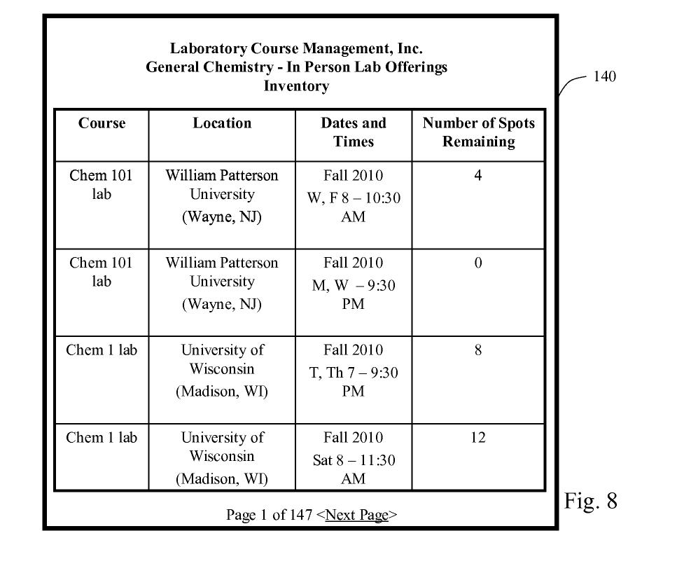

FIG. 8 displays offerings for online course and remote laboratory portion of course 140, which comprises information derived from an electronic record of offering of remote laboratory portion of course 110 (various locations and times for Chem 101 lab and Chem 1 lab). In this embodiment, there is also information about how many unfilled spots remain in each remote laboratory course.

According to the invention, course credits accrued at the educational institution comprise a combination of credits for online non-laboratory course work offered by the EI and hands-on laboratory course work completed at one or more remote laboratory. It is understood that the EI credits may include credits for more than one laboratory course at a remote laboratory, or completed at more than one remote laboratory. They may also include credits for online lecture courses or portions of courses completed at more than one EI.

In such an embodiment, the system of the invention would be configured to store records of completion of a remote laboratory portion of a course and to retrieve the records for combining with records of completed online courses and portions of courses in order to display or store a composite record of completed courses toward a degree or certification. In this embodiment, a computer system comprises one or more databases, the databases comprising records pertaining to online courses and also comprising records pertaining to laboratory portions of courses completed at remote laboratories, as illustrated below.

### Examples

Some non-limiting examples will further help to clarify the distinguishing features of the invention. An EI such as University of Phoenix offers extensive online courses and degrees. Although they may have one or more physical locations where students can attend lectures and laboratories in person rather than online, they do not have laboratories in most towns and cities in the United States nor in all towns and cities in other countries. In order to enable their students to receive hands-on laboratory training without having to travel far, according to the present invention they could make arrangements with one or more other universities to enable University of Phoenix students to complete laboratory portions of courses near where the students live. For example, if student A lives in city B, which contains no physical location owned by University of Phoenix, University of Phoenix could make a business arrangement with University C, which is located in city B, to enable student A to attend hands-on laboratory training at University C's laboratory in city B. In this example, student A could complete online coursework (online portion of course) via University of Phoenix's online course offerings, and the student could complete the laboratory portion of the course at University C's laboratory. In this example, University of Phoenix's web sites could be configured to display appropriate listings of online portions of courses and remote laboratory portions of courses to aid the student in deciding which courses to enroll in, or to aid the student in registering for the courses. Furthermore, in this example, University of Phoenix could maintain a computer system configured to store records of completion of a remote laboratory portion of a course and to retrieve the records for combining with records of completed online courses and portions of courses in order to display or store a composite record of completed credits toward a degree or certification. In this example, there could be a record that student A completed a remote laboratory portion of a course at University C and also a record indicating that Student A completed an online portion of a course at University of Phoenix.

In another example of an embodiment of the invention, University of Phoenix could form partnerships with hundreds of universities around the world to enable students in many different locations to complete remote laboratory portions of courses in remote laboratories.

In another example of the invention, University of Phoenix (an online university) could contract with a company Z, said company Z being a company that manages the process of identifying and arranging remote laboratory portions of courses. For example, company Z may form partnerships with many different universities that wish to offer remote laboratory portions of courses in order to facilitate the process by which University of Phoenix and other EIs identify and offer suitable remote laboratory portions of courses. Such an arrangement would also benefit said different universities because it would enable them to fill some of the empty spots in their ongoing laboratory courses. Thus, a given laboratory course at one of said different universities (university P in this example) might contain some students that are taking the related lecture part of the course online at University of Phoenix, and at the same time contain other students that are taking the related lecture part of the course at university P.

In another example of the invention, University of Phoenix could contract with a company Y, said company Y being a company that owns and manages remote laboratories, and offers remote laboratory portions of courses. For example, company Y may form partnerships with many different EIs that wish to offer remote laboratory portions of courses to go along with online courses offered by the same EIs. In this case, students can complete the remote laboratory portions of courses at facilities owned and managed by company Y, and the students can complete online portions of courses via University of Phoenix's or other EIs online course offerings.

In some embodiments, laboratory portions of courses may be laboratory portions of existing courses at other universities. In the example above, University C may offer an Introductory Chemistry Course (Chem 101), which comprises lectures and laboratory classes. Students of University of Phoenix may attend just the Chem 101 laboratory classes at University C. In this example, University of Phoenix benefits by enabling their student to receive hands-on training without having to travel long distances, and University C benefits by increasing utilization of their laboratory assets, for which they receive remuneration by University of Phoenix. A suitable substitute for the lecture portion of Chem 101 could be completed online via University of Phoenix's online course offerings.

Even though an educational institution may have excellent laboratory facilities at its campus, students taking online courses offered by the educational institution may live far away from its campus and may benefit from this invention by attending a laboratory portion of a course at a remote laboratory.

### Additional Details

It will be understood by those of ordinary skill in the art that multiple colleges or universities within a state university system can be considered different entities for the purposes of this disclosure. Thus, for example, if University of California at Berkeley offers an online portion of a course, and accepts credits for a laboratory portion of a course completed at University of California at Los Angeles, the laboratory portion of the course would be considered a remote laboratory course portion. The distinction is that these two universities are run as independent universities with separate admissions committees, rankings, administrations, campuses, etc.

In some preferred embodiments, a distinguishing feature is that the online courses and the remote laboratory courses can be taken by a student concurrently, or near in time. For example, during a single semester, a student may take an online course at the EI and also take a remote laboratory course at a second college or university. Or, a student may take an online course at the EI during one semester, and then may take a remote laboratory course during the next semester without ever having to change locations of residence.

This system and method can enable dynamic pricing of remote laboratory courses based on number of available slots at any given time. For example, based on the number of available slots in a remote laboratory course, pricing may vary similar to the way it does in the airline and hotel industry, and this dynamic pricing can be automated.

The systems and methods of this invention require various electronic records to be created, stored, retrieved, modified, shared, accessed, displayed, etc. This includes between the educational institution and the remote laboratory course management system. It also includes between students (or prospective students) and educational institutions, and between students (or prospective students) and companies operating remote laboratory course management systems. It also includes between students (or prospective students) and colleges or universities offering remote laboratory courses, or between educational institutions or remote laboratory course management system and colleges or universities offering remote laboratory courses. Information technology systems and methods for carrying out such activities are well known and widely used in other areas, for example, in the area of health record management. Methods for such activities, including keeping electronic records and databases, and sharing them over computers or networks, are described in U.S. Pat. Nos. 8,311,848, 8,260,637, 8,239,218, 8,239,216, 8,108,311, 8,037,052, 7,949,545, 7,461,079, 7,331,464, and 6,684,276, and United States patent applications 2013/004,1689, 2013/003,0838, 2013/002,4206, 2012/031,0673, 2012/031,0666, 2012/029,6674, 2012/029,0328, 2012/024,5954, 2012/010,9686, 2012/009,5923, 2012/005,4165, and 2011/025,1854.

In some embodiments of this invention, geolocation services may be utilized to automatically identify remote laboratory portions of courses available to the clients for their particular geolocation. Some location-based services useful for this invention are described in U.S. Pat. No. 6,944,447.

The various databases and records utilized in this invention can reside at the physical location of the EIs or the colleges or universities offering remote laboratory courses, at a third party database, or they may utilize cloud storage, cloud database management, or other cloud computing techniques such as those described in U.S. patent application 2013/003,1136.

We claim:

1. A method for storing and retrieving records pertaining to course completion, the method comprising:
creating a record of completion of one or more online portions of a course;
inputting the record of completion of the one or more online portions of a course into a first general purpose computer, the first general purpose computer comprising:
one or more first computer input devices,
one or more first computer display devices, and
one or more first computer processors;
transmitting the record of completion of the one or more online portions of a course from the one or more first computer processors to a first database;
creating a record of completion of a remote laboratory portion of a course;
inputting the record of completion of the remote laboratory portion of the course into a second general purpose computer, the second general purpose computer comprising:
one or more second computer input devices,
one or more second computer display devices, and
one or more second computer processors; AND
transmitting the record of completion of the remote laboratory portion of the course from the one or more second computer processors to a second database.

2. The method of claim 1, wherein the first general purpose computer and the second general purpose computer are the same general purpose computer, and
wherein the first database and the second database are the same database.

3. The method of claim 1, further comprising:
inputting a request to display one or more composite course completion records into a third general purpose computer, the third general purpose computer comprising:
one or more third computer input devices,
one or more third computer display devices, and
one or more third computer processors;
transmitting one or more requests for a record of completion of one or more online portions of a course from the one or more third computer processors to the first database;
receiving one or more records of completion of the one or more online portions of a course from the first database into the one or more third computer processors;
transmitting one or more requests for a record of completion of the remote laboratory portion of a course from the one or more third computer processors to the second database;
receiving one or more records of completion of the remote laboratory portion of the course from the second database into the one or more third computer processors;
assembling one or more composite course completion records from the one or more records of completion of the one or more online portions of a course and the one or more records of completion of the remote laboratory portion of the course by the one or more third computer processors;
formatting the one or more composite course completion records for output to the one or more third computer display devices; AND
transmitting the one or more composite course completion records to the one or more third computer display devices.

4. The method of claim 3, wherein the first general purpose computer and the third general purpose computer are the same general purpose computer.

5. The method of claim 3, wherein the second general purpose computer and the third general purpose computer are the same general purpose computer.

6. The method of claim 3, wherein the first general purpose computer, the second general purpose computer, and the third general purpose computer are the same general purpose computer, and
wherein the first database and the second database are the same database.

7. A method for retrieving and displaying information relating to courses, each course having at least one online portion and at least one remote laboratory portion, the method comprising:
inputting a request for course information for one or more courses on a general purpose computer, the general purpose computer comprising:
one or more input devices,
one or more display devices,
one or more processors, and
a network interface;
receiving the request for course information from the one or more input devices into the one or more processors,
transmitting a request for course information for one or more online portions of a course from the one or more processors to a first database through the network interface,
receiving the course information for the one or more online portions of the course from the first database into the one or more processors through the network interface,
transmitting a request for course information for one or more remote laboratory portions of one or more courses from the one or more processors to a second database through the network interface,
receiving the course information for the one or more remote laboratory portions of the one or more courses from the second database into the one or more processors through the network interface,
assembling composite course information from the course information for one or more online portions of the course and the course information for one or more remote laboratory portions of one or more courses by the one or more processors,
formatting the composite course information for output to the one or more display devices by the one or more processors, AND
transmitting the composite course information as formatted by the processor from the one or more processors to the one or more display devices.

8. The method of claim 7, wherein the first database and the second database are the same database.

9. The method of claim 7, wherein the request for course information for one or more courses comprises student location data,
wherein the course information for the one or more remote laboratory portions of the one or more courses comprises remote laboratory location data, and
wherein the step of assembling composite course information comprises ranking the course information for the one or more remote laboratory portions of the one or more courses using the student location data and the remote laboratory location data.

10. The method of claim 9, wherein the first database and the second database are the same database.

11. A system for storing and retrieving records pertaining to course completion, the system comprising:
a record of completion of an online portion of a course;
a record of completion of a remote laboratory portion of a course;
a first database;
a second database;
a first general purpose computer, the first general purpose computer comprising:
one or more first computer input devices,
one or more first computer display devices, and
one or more first computer processors having instructions for:
receiving the record of completion of the online portion of the course from the one or more first computer input devices, and
transmitting the record of completion of the online portion of the course to the first database;
a second general purpose computer, the second general purpose computer comprising:
one or more second computer input devices,
one or more second computer display devices, and
one or more second computer processors having instructions for:
receiving the record of completion of the remote laboratory portion of the course from the one or more second computer input devices, and
transmitting the record of completion of the remote laboratory portion of the course to the second database; AND
a third general purpose computer, the third general purpose computer comprising:
one or more third computer input devices,
one or more third computer display devices, and
one or more third computer processors having instructions for:
transmitting one or more requests for a record of completion of an online portion of a course to the first database,
receiving one or more records of completion of the online portion of the course from the first database,
transmitting one or more requests for a record of completion of the remote laboratory portion of a course to the second database,
receiving one or more records of completion of the remote laboratory portion of the course from the second database,
assembling one or more composite course completion records from the one or more records of completion of the online portion of the course and the one or more records of completion of the remote laboratory portion of the course,
formatting the one or more composite course completion records for output to the one or more third computer display devices, and
transmitting the one or more composite course completion records to the one or more third computer display devices.

12. The system of claim 11, wherein the first database and the second database are the same database.

13. The system of claim 11, wherein the first general purpose computer, the second general purpose computer, and the third general purpose computer are the same general purpose computer, and
wherein the first database and the second database are the same database

14. A system for retrieving and displaying information relating to courses, the system comprising:
at least one online portion of a course;
at least one remote laboratory portion of a course;
a first database comprising course information for one or more online portions of courses;
a second database comprising course information for one or more remote laboratory portions of one or more courses; AND
a general purpose computer, the general purpose computer comprising:
one or more input devices,
one or more display devices,
a network interface, and
one or more processors having instructions for:
receiving a request for course information from the one or more input devices,
transmitting a request for course information for one or more online portions of courses to the first database through the network interface,
receiving the course information for the one or more online portions of courses from the first database through the network interface,
transmitting a request for course information for one or more remote laboratory portions of one or more courses to a second database through the network interface,
receiving the course information for the one or more remote laboratory portions of the one or more courses from the second database through the network interface,
assembling composite course information from the course information for one or more online portions of courses and the course information for one or more remote laboratory portions of one or more courses,
formatting the composite course information for output to the one or more display devices, and
transmitting the composite course information to the one or more display devices.

15. The system of claim 14, wherein the first database and the second database are the same database.

16. The system of claim 14, wherein the request for course information for one or more courses comprises student location data,
wherein the course information for the one or more remote laboratory portions of the one or more courses comprises remote laboratory location data, and
wherein the instructions for assembling composite course information comprises ranking the course information for the one or more remote laboratory portions of the one or more courses using the student location data and the remote laboratory location data.

17. The system of claim 16, wherein the first database and the second database are the same database.
